(19) United States
(12) Patent Application Publication
(10) Pub. No.: US 2017/0198772 A1
(43) Pub. Date: Jul. 13, 2017

(54) Particle Trapping Brake Assembly With Deflector

(71) Applicant: TALLANO TECHNOLOGIE, Paris (FR)

(72) Inventor: Christophe Rocca-Serra, Paris (FR)

(73) Assignee: TALLANO TECHNOLOGIE, Paris (FR)

(21) Appl. No.: 15/405,855

(22) Filed: Jan. 13, 2017

(30) Foreign Application Priority Data
Jan. 13, 2016 (FR) 16 50264

(51) Int. Cl. B60T 13/46; F16D 55/24

(52) U.S. Cl. CPC F16D 65/0031; F16D 65/092; F16D 55/226; F16D 2200/003

(57) ABSTRACT

A non-polluting brake assembly comprising a caliper bracket, a rotor disc, two movable pads clamped by a caliper, the pads comprising friction material capable of releasing particles resulting from abrasion, and a suction device arranged at least partially in proximity to the caliper bracket, the suction device comprising, in proximity to each pad, a suction zone delimited by a deflector and in which a negative pressure is created, characterized in that the deflector comprises at least one portion located in an external radial position relative to the pad.

### TECHNICAL FIELD

The present invention relates to non-polluting braking systems, particularly those intended for use in road or railway vehicles. The invention relates in particular to braking systems capable of capturing by suction the particles and dust resulting from abrasion that are emitted by friction braking.

It is known that these particles are harmful to the health when released into the ambient environment. Advances in electric motors for motor vehicles have reinforced the need to treat the particles and dust resulting from the abrasion of friction brake systems.

### PRIOR ART

Document WO2014072234 discloses a simple and fully autonomous device based on the principle of suction occurring as close as possible to the pad/disc interface.

However, the rate of capture is not optimum because it depends on the aerological conditions and in particular on the relative wind prevailing in the immediate vicinity of the brake pad.

There is therefore a need to improve the solutions in order to capture the particles and dust resulting from braking in a manner that eliminates some or all of the aforementioned disadvantages.

### SUMMARY OF THE INVENTION

To this end, the present invention proposes a non-polluting brake assembly comprising:
a caliper bracket,
a rotor disc, rotating about an axis X relative to which a radial direction R is defined,
two movable pads intended to bear against said disc so as to brake it under a clamping force provided by a caliper, the pads comprising friction material capable of releasing particles resulting from the abrasion,
and a suction device arranged at least partially in proximity to the caliper bracket and attached thereto,
   the suction device comprising, in proximity to each pad, a suction zone delimited by a deflector and in which a negative pressure is created,
   characterized in that the deflector comprises at least one first extension located in an external radial position relative to the pad.

With these arrangements, it is possible to increase the particle capture rate under diverse aerological conditions around the brake assembly.

Specifically, one will note that the suction zone ZA is mainly located at the front of the pad relative to the normal direction of rotation FW of the disc, but changes in the local aerology can result in the particles not all being released in a tangential direction, and advantageously the first extension makes it possible to capture the particles tending to move outward.

In various embodiments of the invention, one or more of the following arrangements may possibly be used:
the deflector comprises at least one second extension located in an internal radial position relative to the pad. The suction zone ZA is thus further optimized, in particular for particles tending to move inward;
the suction device may be entirely arranged in proximity to and attached to the caliper bracket, and the suction device further comprises:
   at least one tank for collecting the particles,
   a pipe leading from the suction zones to the tank,
   an impeller driven by drive means and configured to create a negative pressure in the tank; thereby improving the mechanical integration and autonomy;
the drive means may be mechanical and then comprise a roller rubbing on the disc; thus providing complete autonomy.
the drive means may be electric and comprise an electric motor controlled by a control unit; this provides versatility and flexibility in its control.
the deflector has an edge closest to the disc which is advantageously at a distance (H) from the disc surface of between 1 and 2 mm;
according to one embodiment, the deflector may be integrally molded with the caliper bracket; which simplifies the architecture of the solution and makes it possible to reduce the cost—note that this does not preclude further machining;
in which case the pipe may be formed in part by a through-hole in the caliper bracket; the compactness of the solution is further improved;
the deflector is a separate part made of cast aluminum material; this material can withstand the high temperatures which may prevail at that location;
in one embodiment, the free edge of the deflector fits closely and continuously against the front end of the pad lining and at least partially against the internal radial portion and the external radial portion, the free edge of the deflector being at a distance (K) in the tangential direction from the lining of between 0.5 mm and 1.5 mm; there is thus necessary and sufficient play to accommodate statistical dispersion in manufacturing and in capture quality.

### BRIEF DESCRIPTION OF DRAWINGS

Other features, objects, and advantages of the invention will become apparent upon reading the following description of two embodiments of the invention, given as non-limiting examples. The invention will also be better understood with reference to the accompanying drawings, in which:

FIG. 1A is a general view of a brake assembly according to a first embodiment of the invention,

FIG. 1B is a general view, similar to FIG. 1A, of a brake assembly according to a second embodiment of the invention,

FIG. 2 is a cross-sectional view,

FIG. 3 shows an explanatory diagram of particle trajectories,

FIG. 4A is an exploded view of the brake assembly according to the first embodiment,

FIG. 4B is an exploded view of the brake assembly according to the second embodiment,

FIG. 5 illustrates the capture zone,

FIG. 6 illustrates the interface area between the pad and the deflector.

### DETAILED DESCRIPTION OF THE INVENTION

In the various figures, the same references designate identical or similar elements. It should be noted that the drawings are not necessarily to scale, with some dimensions exaggerated for clarity in the description, in particular certain safety clearances or gaps.

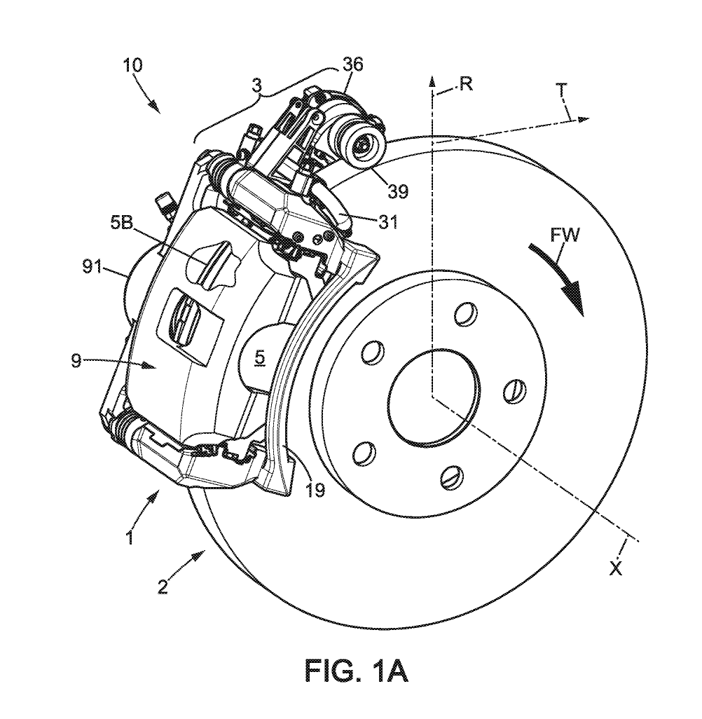

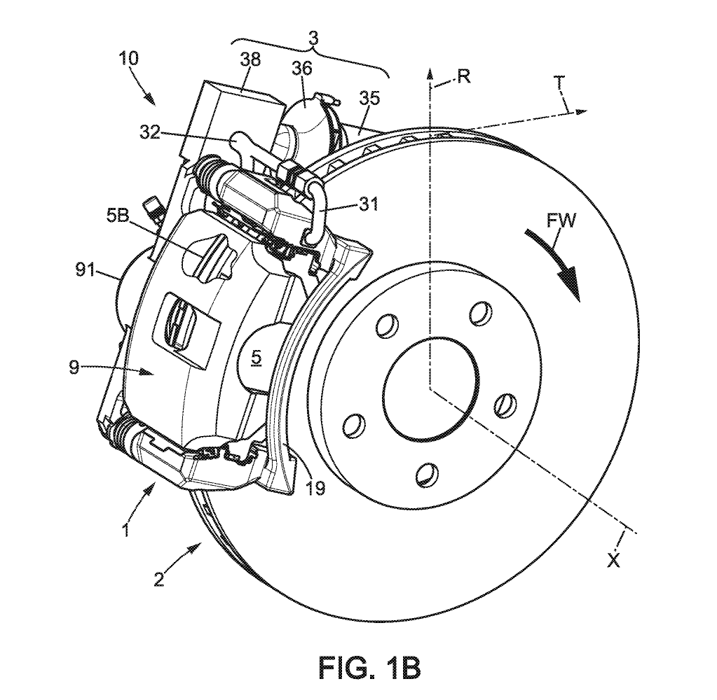

FIG. 1A shows a brake assembly 10 according to a first embodiment of the invention which relates to a disc brake configuration. Such a disc brake configuration is very common in automobiles, utility vehicles, heavy-duty vehicles, and buses, as well as in railway rolling stock and two-wheeled vehicles. In this configuration, the braking action is applied to a rotor called a “disc” that is integral with the wheel rim but distinct from it.

There are increasing numbers of particles emitted by braking systems due to the increase in vehicular traffic, especially in urban areas. Medical studies confirm the harmfulness of these particles to the respiratory system and to health in general. It is therefore important to substantially reduce the release of these particles into the ambient environment, which is the object of the invention.

Although efforts are being made to use friction-free braking systems where possible, such as regenerative electric braking or eddy current braking, it turns out that friction braking systems cannot be entirely eliminated because they are efficient at all speeds, they allow keeping a vehicle at a standstill, and they provide an adequate and effective solution for emergency braking.

In friction braking, the braking is based on a rotor 2 rotating about an axis X of a wheel onto which two pads apply friction in order to reduce its speed by transforming kinetic energy into heat. The rotation about the axis X makes it possible to define a tangential (or circumferential) direction T and a radial direction R (locally orthogonal to the axis and to the tangential direction T).

A normal direction of rotation FW which corresponds to forward travel is also defined. It should be noted that for railway equipment, which travels in either direction, the suction device described below can be duplicated in order to handle the direction opposite to FW.

As illustrated in FIGS. 1A to 4B, and in common with the various embodiments, the brake assembly 10 comprises a rotor 2 in the form of a disc of constant thickness integral with the wheel to be braked (or wheels of the axle to be braked), and two pads 5, 5B (also called “brake pads”) designed to bear against said rotor, in order to brake it, by means of the action of a brake caliper 9.

The disc comprises a hub, a first annular side face denoted 21 perpendicular to axis X, and a second annular face 22 parallel to the first; the radially outer edges of the side faces are connected by a rim called a disc edge 23.

The brake caliper 9 is attached by a floating mounting to a caliper bracket 1. This mounting, which floats along X, for example on pins 95 (also known as “guide pins”), is well known and is therefore not further described.

The caliper bracket 1 comprises a clevis 11, intended to be rigidly fixed to the suspension arm or to the hub carrier, and U-shaped connectors (also sometimes referred to as “bridges”) straddling the disc: more precisely a first bridge 12 on the front side, a second bridge 13 on the rear side, and a connecting arc 19 which connects the bridges opposite the clevis.

In the case of a road vehicle, the clevis 11 is arranged on the inward side of the vehicle relative to the disc 2, and the connecting arc 19 is arranged on the outward side of the vehicle relative to the disc 2. The clevis 11 is intended to be fixed to the suspension arm or the hub carrier, by means of holes 17 which receive fastening screws.

The pads 5 are mounted so as to be movable along X with respect to the caliper bracket 1, but they are substantially immobilized in the circumferential direction T and in the radial direction R by means of complementary shapes, as will be detailed further below.

The pads 5 are housed inside the brake caliper 9 and surround the disc 2 with their linings respectively facing the first disc face 21 and the second disc face 22.

As is known per se, the two pads 5, 5B can be urged towards each other by a piston 91 so that they sandwich the rotor 2, producing a force PF directed parallel to the axial direction X of the wheel. The caliper has a generally U-shaped configuration and comprises a body 90 and fingers 92 arranged opposite the piston 91.

Each pad 5 has a metal backing 50 and a pressure-applying body 51 comprising friction material likely to release particles 8 resulting from the abrasion due to friction. The pressure-applying body is also called the “lining” 51 and the friction material is sometimes referred to by its brand name. The friction face is denoted 52, and as the lining 51 wears, this face moves progressively closer to the backing plate 50.

The backing plate 50 comprises a tongue 56 at each end, each tongue being received in a form-fitting housing 14 of the caliper bracket 1. This provides immobilization in the tangential T and radial R directions and the housing allows movement of the tongue in the axial direction X.

According to the invention, the brake assembly 10 comprises a suction device 3 able to capture the particles and dust 8 resulting from abrasion due to braking.

The suction device 3 has dimensions that facilitate its integration into the immediate environment of the caliper bracket 1.

More specifically, the suction device 3 comprises:
a suction zone ZA with a deflector 4, which makes it possible to define a capture zone close to the pad lining,
a collection tank 38 for collecting the particles of friction material 8,
a pipe 31, 32 leading from the suction zone ZA to the collection tank 38, namely a first pipe 31 for one side and a second pipe 32 for the other side, possibly with a common segment leading to the tank,
an impeller 36, driven by driving means which will be described below, and which can thus create a negative pressure in the tank.

A filter is provided in the tank; the filter allows the passage of air in order to create the negative pressure, but not of particles 8.

A negative pressure is created in the tank 38 by the rotation of the impeller. This negative pressure also prevails in the pipe, in the suction mouth 47, and in the capture zone ZA delimited by the deflector 4. The negative pressure is sufficient to draw the particles from the capture zone ZA to the tank 38.

In other words, the deflector 4 defines, together with the disc 2 and the lining 51, a somewhat enclosed space called the suction zone ZA.

Advantageously, and unlike certain solutions of the prior art, no blowing is used which would result in dispersion of the particles.

According to one advantageous aspect, the deflector comprises a first extension 41 located in an external radial position relative to the pad.

It is also possible for the deflector to comprise a second extension 42 located in an internal radial position relative to the pad.

As illustrated in FIG. 3, depending on the aerology prevailing at time t, ejection of the particles does not necessarily occur in a strictly tangential ejection configuration ET. In fairly frequent cases, a centrifugal ejection EF is observed, and in other more rare cases a centripetal ejection EP may even be observed. Of course, there can be significant dispersion in the trajectories, with centrifugal and centripetal ejections at the same time.

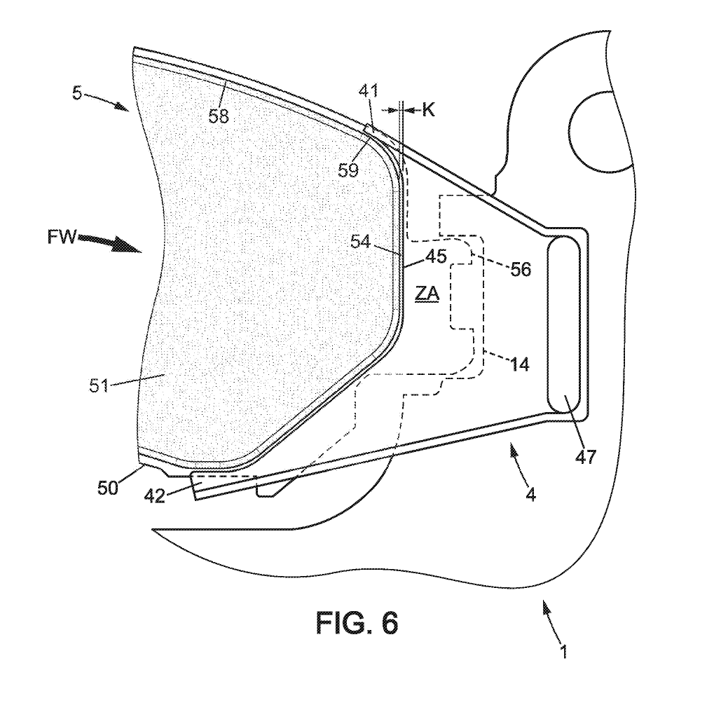

It can be seen that the coverage from the extensions 41, 42, respectively located in external and internal radial positions, is fairly extensive in FIG. 3 but less extensive in FIG. 6.

In practice, the lining has an outer edge 58 forming an arc of a circle centered on X, this outer edge having a front end 59, and the inventor has determined that the external extension 41 must extend at least to said front end 59 (see FIG. 6). Preferably, the external extension 41 covers the front end 59 of the outer edge 58 forming an arc of a circle.

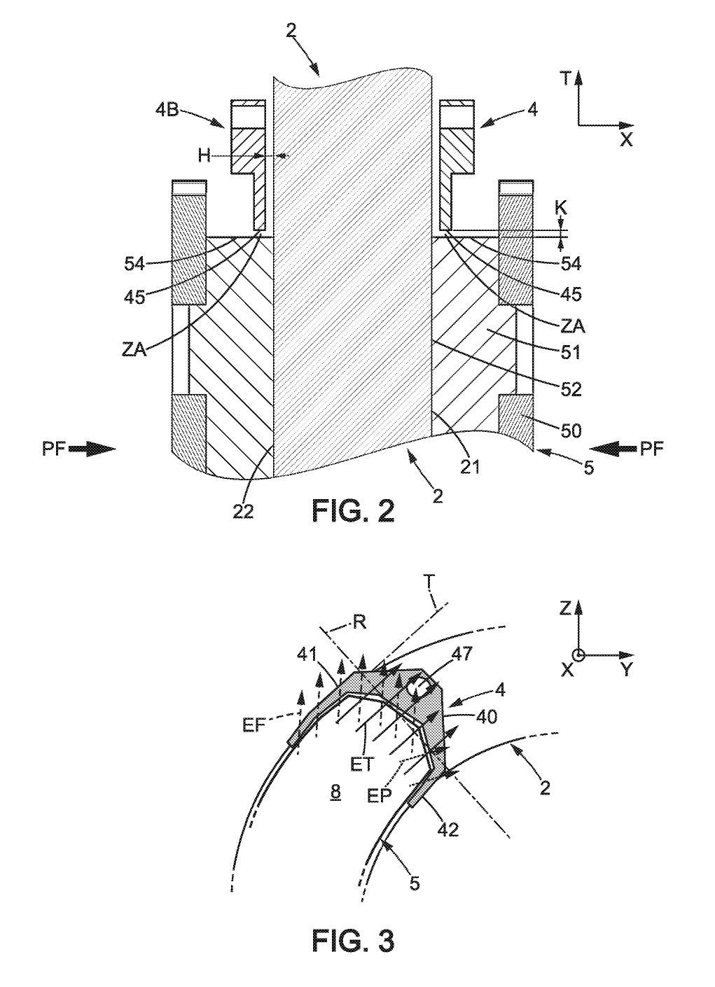

As shown in FIG. 2, the deflector 4 has an edge closest to the disc which is located at a distance H from the surface of the disc of between 1 and 2 mm. In other words, H is the clearance of the deflector 4 with respect to the surface of the disc. One will note that in FIG. 2, the caliper bracket 1 is not represented.

The shape of the free edge 45 of the deflector fits closely and continuously against the front end 54 of the pad lining and at least partially against the internal radial portion and the external radial portion. In one advantageous embodiment, the free edge of the deflector is at a distance K from the lining of between 0.5 mm and 1.5 mm.

The coverage of the deflector is only what is strictly necessary, the impact on the cooling of the pad and other components being minimal.

One will note that the disc 2 is also subject to wear and releases metal particles which are also captured by the suction device.

One will note that until this point the description has been the same for the different embodiments.

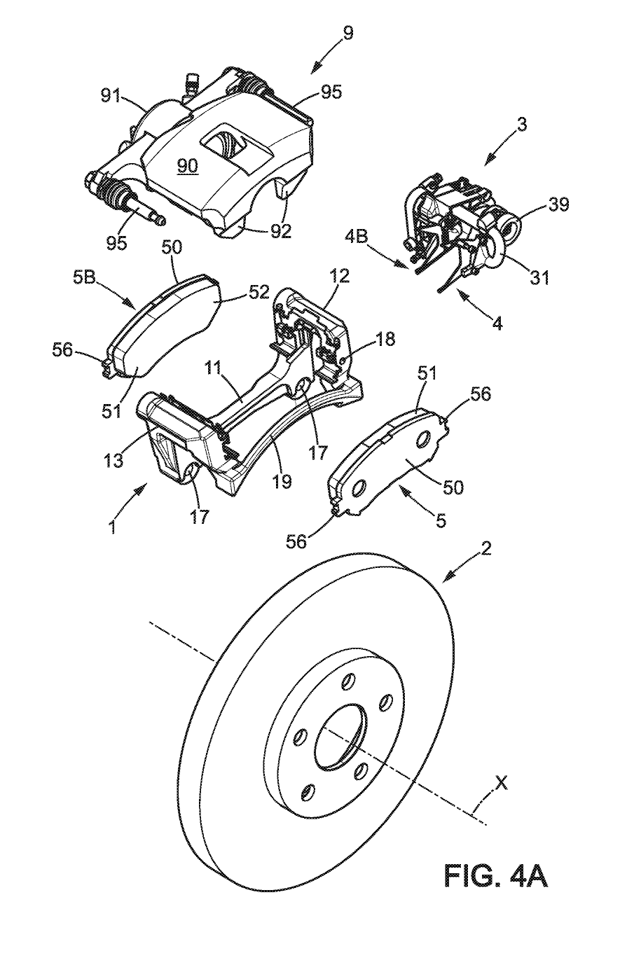

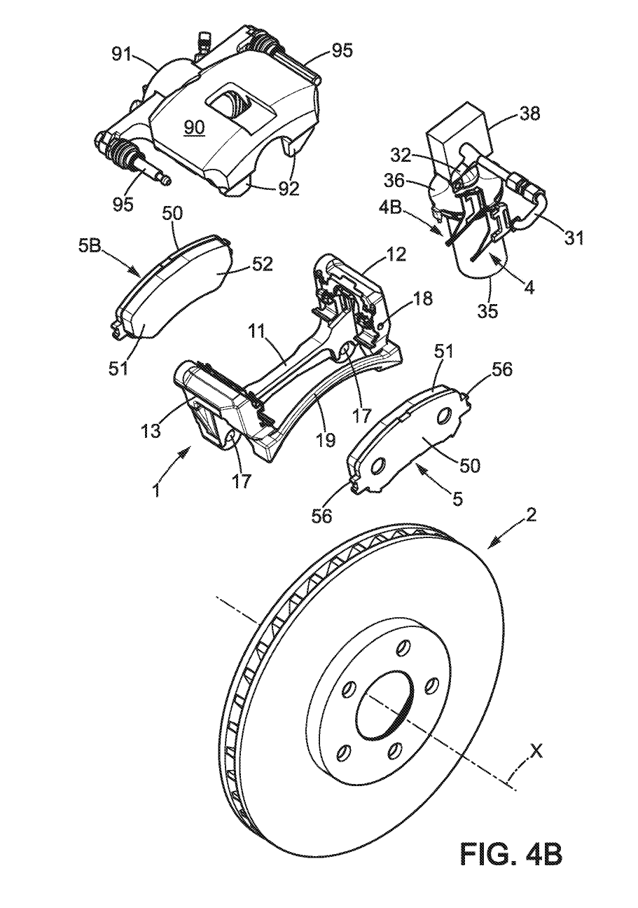

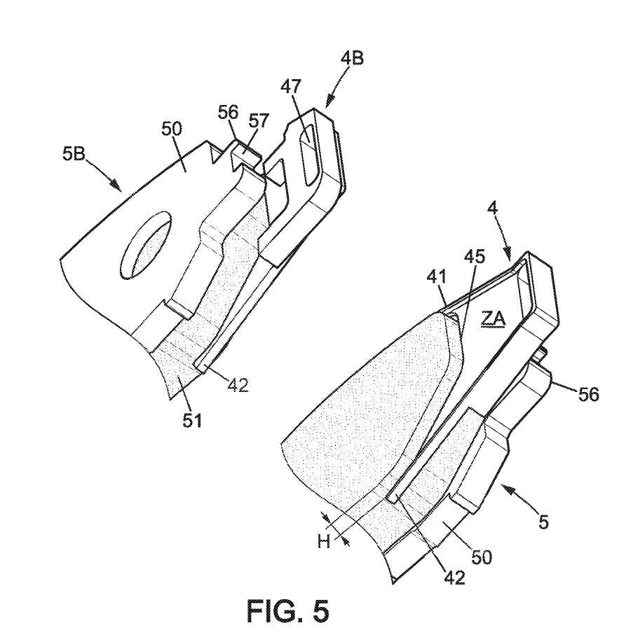

According to the first embodiment represented in particular in FIGS. 1A and 4A, the drive means are based on a mechanical solution already mentioned in document WO02014072234. A roller 39 rests on the edge 23 of the rotor, the roller being driven by friction. A spring-loaded mounting allows adjusting the applied pressure. A step-up/reduction gear may be provided so as to obtain a proportionality constant between the speed of the disc and the speed of the impeller that is satisfactory for the desired negative pressure.

In the example shown, the deflector 4 is a separate part made of material such as cast aluminum.

According to a second embodiment represented in FIGS. 1B and 4B, an electric motor 35 is used as the means for driving the impeller. This electric motor is controlled by a control unit (not shown) comprising software configured to activate the electric motor for example based on driver braking action on the brake pedal.

According to one variant (not shown), one uses a negative pressure generating element in a centralized unit connected by pipes to each of the brake assemblies.

In the example illustrated, the deflector 4 is a separate part made of material such as cast aluminum.

In the two embodiments illustrated, the deflectors 4, 4B are rigidly mounted with respect to the caliper bracket 1. Since the position of the caliper bracket relative to the disc is very precise, the position of the deflectors 4, 4B is properly maintained relative to the disc regardless of the degree of wear of the pad; it is thus possible to obtain a properly maintained dimension H and dimension K (see above), regardless of the residual thickness of the lining 51 of the pad 5.

In the two embodiments illustrated, the deflectors 4, 4B are formed as separate parts made of a material such as cast aluminum.

According to one variant (not shown), the deflector is integrally molded with the caliper bracket 1. In this case, as in the case shown in FIG. 4B, the pipe may be formed in part by a through-hole 18 in the caliper bracket.

Note that according to one variant (not shown), the caliper may be fixedly mounted on the caliper bracket.

1. A non-polluting brake assembly comprising:
a caliper bracket,
a rotor disc, rotating about an axis relative to which a radial direction is defined,
two movable pads intended to bear against said disc so as to brake it under a clamping force provided by a caliper, the pads comprising friction material capable of releasing particles resulting from the abrasion,
and a suction device arranged at least partially in proximity to the caliper bracket,
the suction device comprising, in proximity to each pad, a suction zone delimited by a deflector and in which a negative pressure is created,
wherein the deflector comprises at least one first extension located in an external radial position relative to the pad and in that the deflector is integrally molded with the caliper bracket.

2. The brake assembly as claimed in claim 1, wherein the deflector comprises at least one second extension located in an internal radial position relative to the pad.

3. The brake assembly as claimed in claim 1, wherein the suction device is arranged entirely in proximity to and is attached to the caliper bracket, and wherein the suction device further comprises:
at least one tank for collecting the particles,
a pipe leading from the suction zones to the tank,
an impeller driven by drive means and configured to create a negative pressure in the tank.

4. The brake assembly as claimed in claim 3, wherein the drive means are mechanical and comprise a roller rubbing on the disc.

5. The brake assembly as claimed in claim 3, wherein the drive means are electric and comprise an electric motor controlled by a control unit.

6. The brake assembly as claimed in claim 1, wherein the deflector has an edge closest to the disc which is at a distance from the disc surface of between 1 and 2 mm.

7. The brake assembly as claimed in claim 1, wherein the pipe is formed in part by a through-hole in the caliper bracket.

8. The brake assembly as claimed in claim 1, wherein the free edge of the deflector fits closely and continuously against the front end of the pad lining and at least partially against the internal radial portion and the external radial portion, the free edge of the deflector being at a distance in the tangential direction from the lining of between 0.5 mm and 1.5 mm.
